(19) United States
(12) Patent Application Publication
(10) Pub. No.: US 2026/0265877 A1
(43) Pub. Date: Sep. 10, 2026

(54) DUCTILE HIGH-TEMPERATURE STRENGTH REFRATORY HIGH-ENTROPY ALLOYS (RHEAs) AND METHODS OF MAKING

(71) Applicant: National Technology & Engineering Solutions of Sandia, LLC, Albuquerque, NM (US)

(72) Inventor: Salvador B. Rodriguez, Albuquerque, NM (US)

(21) Appl. No.: 19/557,632

(22) Filed: Mar. 5, 2026

Related U.S. Application Data
(60) Provisional application No. 63/767,760, filed on Mar. 6, 2025.
(60) Provisional application No. 63/767,772, filed on Mar. 6, 2025.

(51) Int. Cl. C22C 30/00; B22F 10/14; B22F 10/64; B33Y 10/00; B33Y 40/20; B33Y 70/00

(52) U.S. Cl. CPC C22C 30/00; B22F 10/14; B22F 10/64; B33Y 10/00; B33Y 40/20; B33Y 70/00; B22F 2301/20; B22F 2998/10; B22F 2999/00

(57) ABSTRACT

RHEA alloys that have the high-strength/high-temperature of Inconel alloys while retaining the erosion-, corrosion-, and radiation-resistance of RHEA alloys are disclosed. The RHEA alloy includes an element selected Ni, Co and Fe.

### RELATED APPLICATIONS

This application claims priority to U.S. Patent Provisional Application 63/767,760, filed Mar. 6, 2025, entitled “DUCTILE HIGH-TEMPERATURE STRENGTH REFRACTORY HIGH-ENTROPY ALLOYS (RHEAs),” and to application U.S. Patent Provisional Application 63/767,772, filed Mar. 6, 2025, entitled “BINDER JET MANUFACTURING OF REFRACTORY HIGH-ENTROPY ALLOY (RHEA) AND REFRACTORY HIGH-ENTROPY INCONEL (RHEINCONEL) ALLOY ARTICLES,” the entireties of which are incorporated herein by reference.

### GOVERNMENT INTEREST STATEMENT

This invention was made with Government support under Contract No. DE-NA0003525 awarded by the United States Department of Energy/National Nuclear Security Administration. The U.S. Government has certain rights in this invention.

### FIELD OF THE INVENTION

The present invention is directed to refractory high-entropy alloys (RHEAS), RHEAS that include a non-refractory ductile element and binder jet manufacturing of articles thereof.

### BACKGROUND OF THE INVENTION

Inconel is a super alloy developed for high-strength/high-temperature applications, with millions of dollars spent optimizing its elemental composition and post-processing. By contrast, refractory high-entropy alloys (RHEAs) have excellent high-temperature strength as well as erosion-, corrosion-, and radiation-resistance. Several RHEA combinations have exceeded the performance of Inconel, but unlike Inconel, RHEAs are notoriously brittle at room temperature.

Several RHEA combinations have exceeded the performance of Inconel, but unlike Inconel, RHEAs are notoriously brittle at room temperature. First discovered in 2012, RHEAs are alloy combinations typically consisting of four to six refractory elements in near-equiatomic proportions, e.g., a four element RHEA has 25% composition for each element in its chemical composition, and so forth. Because of their equiatomic formation based on refractory elements and the subsequent generation of non-uniform crystals formed by atoms dispersed uniformly throughout the alloy, RHEAs have excellent high-temperature strength as well as erosion-, corrosion-, and radiation-resistance. It is noted that the much studied and optimized Inconel 718 alloy consists of various amounts of six refractory elements: 17 to 21% Cr, 2.8 to 3.3% Mo, about 0.35% Mn, 4.75 to 5.5% Nb and Ta, 0.65 to 1.15% Ti, plus 50 to 55% Ni. Moreover, refractory elements have the highest melting temperature of the elements in the periodic table, and higher melting temperature is associated with higher yield strength.

Binder jetting (BJG) has been used successfully to manufacture many superalloys, including Inconel 718, but it has not been used to manufacture refractory high-entropy alloys (RHEAs) and related alloys, such as RHEInconel alloys.

Known RHEA alloy manufacturing processes have suffered from non-homogeneous elemental dispersion in the alloy. These processes are also energy intensive, costly and difficult to form in desirable forms.

What is needed are RHEA alloys and methods of making that have the high-strength/high-temperature of Inconel alloys while retaining the erosion-, corrosion-, and radiation-resistance of RHEA alloys.

### SUMMARY OF THE INVENTION

The present disclosure is directed to ductile, high-strength alloy that combines a RHEA and Inconel composition. This composition synergistically merges several synergistic RHEA and Inconel compositional and manufacturing approaches.

The present disclosure is directed to binder jet manufacturing methods of making RHEAS and ductile, high-strength RHEInconel alloys that combines a RHEA and Inconel composition.

According to an embodiment of the invention, an alloy is disclosed having an equiatomic amounts of three, four, five or six refractory elements selected from the group consisting of chrome (Cr), molybdenum (Mo), manganese (Mn), niobium (Nb), tantalum (Ta) and titanium (Ti); and an atomic amount of a non-refractory element selected from the group consisting of nickel, cobalt or iron that is greater than zero and less than or equal to five compared to one of the refractory elements.

According to another embodiment of the disclosure, an alloy is disclosed having the formula CrMoMnNbNiₓTaTi or CrMoNbNiₓTi, where x is greater than zero and less than or equal to five.

According to another embodiment of the disclosure, binder jet manufacturing (BJM) methods are disclosed to form RHEAS and RHEAS with a ductile metal component.

### DETAILED DESCRIPTION OF THE DISCLOSURE

According to an embodiment of the disclosure, the disclosed ductile RHEA compositions are based on the following six refractory elements found in Inconel 718: Cr, Mo, Mn, Nb, Ta, and Ti to which a non-refractory element selected from the group Ni, Co and Fe is added. The number of refractory elements is between 3 and 6 in equiatomic amounts. In an embodiment, the non-refractory element is Ni. The non-refractory element is added to the refractory elements greater than zero and less than or equal to 1 atomic amount. For example, in an embodiment the RHEA is CrMoMnNbNiₓTaTi or CrMoNbNiₓTi, where x is greater than zero and less than or equal to five. In another embodiment, x is greater than zero and less than or equal to 1. In an embodiment, the ductile RHEA is CrMoNbNiTi or CrMoNbNi_{1/2}Ti. In other embodiments, the RHEA may contain any three to six of the stated refractory elements and Ni. In an embodiment, no more than five total elements, four refractory and Ni are combined to form the alloy.

Although Ni is not considered as a “refractory” element, it has a melting temperature that is higher than some refractory elements. Hence, it is not surprising that the above seven elements constitute a significant portion of Inconel's composition, which readily contributes to its effectiveness. Hence, it is decided to form a more ductile, higher-strength RHEA-Inconel alloy, such as CrMoMnNbNiₓTaTi, by merging several synergistic RHEA-Inconel elements with a ductile element selected from Ni, Co and Fe.

The alloy may be manufactured by one of the following approaches:
Base the composition on the following three to six refractory elements found in Inconel 718: Cr, Mo, Mn, Nb, Ta, and Ti. Add Ni, Co or Fe to the set of refractory elements to provide for 1) superior temperature/strength performance, 2) lower cost per unit pound vs. refractory elements, 3) ability to form gamma prime compounds (generates the so-called ‘stress anomaly’, which increases yield strength as temperature increases); strong potential for blocking dislocation propagation, 4) smaller atomic radius than all the refractory elements, which is crucial for self-healing and atomic diffusion, 5) corrosion resistance, 6) ductility, 7) propensity to form FCC crystals, and 8) predominant composition in Inconel.
Vary the Niₓ amount to modify the strength vs. ductility of the RHEA, for example CrMoMnNbNiₓTaTi, where x can vary from greater than 0 to less than or equal to 5.
Apply the refractory elements in equiatomic compositions.
Process the combined elements by a conventional processing or by binder jet manufacturing as described below.

In an embodiment, ductile RHEA may be CrMoMnNbNiₓTaTi formed of seven elements. In other embodiments, a total of five elements are selected. RHEA entropy increases as R times the log of the number of different elements, where R is the gas constant. Hence, a RHEA with five elements has log(5)/log(4) more entropy than a RHEA with only four elements, and so forth. In theory, higher RHEA entropy translates to higher strength. It has been shown that as the number of elements increases, the likelihood of forming face centered cubic (FCC) crystals drops sharply, while becoming more likely that body centered cubic (BCC) crystals will be formed. This is an important observation to note, as FCC alloys and elements tend to be ductile.

In another embodiment, a RHEA composition to be formed into an article is a RHEA having four to seven equiatomic elements without the addition of a ductile non-refractory metal formed by BJM with appropriate RHEA alloy elements as described herein. In an embodiment, BJM RHEA and ductile RHEA alloys were produced with an average grain size of 0.98 microns and an aspect ratio of 1.9, this smaller grain size corresponding to increased material strength.

According to an embodiment, BJM was used to form green parts and sintering was used to solidify the green parts to a high density. In an embodiment, the density was greater than 98% of their theoretical full density. In an embodiment, the density was greater than 99% of their theoretical full density. In an embodiment, the sintering was spark plasma sintering.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An alloy, comprising:
equiatomic amounts of three, four, five or six refractory elements selected from the group consisting of chrome (Cr), molybdenum (Mo), manganese (Mn), niobium (Nb), tantalum (Ta) and titanium (Ti); and
an atomic amount of a non-refractory element selected from the group consisting of nickel, cobalt or iron that is greater than zero and less than or equal to five compared to one of the refractory elements.

2. The alloy of claim 1, wherein an atomic amount of the non-refractory element is greater than zero and less than or equal to 1 compared to one of the refractory elements.

3. The alloy of claim 1, wherein the non-refractory metal is nickel.

4. An alloy, comprising:
the formula CrMoMnNbNiₓTaTi or CrMoNbNiₓTi, where x is greater than zero and less than or equal to five.

5. The alloy of claim 4, wherein an atomic amount of nickel (Ni) is greater than zero and less than or equal to one compared to one of the refractory elements.

6. The allow of claim 4 wherein x is 1 or ½.

7. A method of making an article, comprising:
binder jetting a powder to form a green part by dispersing two or more layers of the powder followed by a layer of a binding agent;
repeating the dispersal of the powder layers and binding agent layers until the green part of a desired thickness is achieved; and
sintering the green part at a temperature and pressure to remove the binding agent and form the article;
wherein the powder is formed of a mixture of refractory high-entropy alloy (RHEA) forming elements selected from the group consisting of four to seven elements of chrome (Cr), molybdenum (Mo), manganese (Mn), niobium (Nb), tantalum (Ta) and titanium (Ti) or a ductile RHEA of three to six elements of chrome (Cr), molybdenum (Mo), manganese (Mn), niobium (Nb), tantalum (Ta) and titanium (Ti) and one element selected from the group consisting of iron (Fe), cobalt (Co) and nickel (Ni).

8. The method of claim 7, wherein the powder is a mixture of separate elemental powder of the forming elements.

9. The method of claim 7, wherein the powder includes alloy powders of two or more of the forming elements.

10. The method of claim 7, wherein the article has a density equal to or greater than 98%.

11. The method of claim 7, wherein the alloy powder is a RHEA powder.

12. The method of claim 7, wherein the alloy powder is a ductile RHEA power.

13. The method of claim 7, wherein the powder comprises:
equiatomic amounts of four, five or six refractory elements selected from the group consisting of chrome (Cr), molybdenum (Mo), manganese (Mn), niobium (Nb), tantalum (Ta) and titanium (Ti); and
an atomic amount of a non-refractory element selected from the group consisting of nickel, cobalt or iron that is greater than zero and less than or equal to five compared to one of the refractory elements.

14. The method of claim 7, wherein an atomic amount of the non-refractory element is greater than zero and less than or equal to one compared to one of the refractory elements.

15. The method of claim 7, wherein the non-refractory metal is nickel.

16. The method of claim 7, wherein the alloy powder has the formula CrMoMnNbNiₓTaTi or CrMoNbNiₓTi, where x is greater than zero and less than or equal to five.

17. The method of claim 15, wherein an atomic amount of nickel (Ni) is greater than zero and less than or equal to one compared to one of the refractory elements.

18. The method of 7, wherein the article has the formula CrMoMnNbNiₓTaTi or
CrMoNbNiₓTi, where x is greater than zero and less than or equal to five.

19. The method of claim 18, wherein an atomic amount of nickel (Ni) is greater than zero and less than or equal to one compared to one of the refractory elements.

20. The method of claim 18, wherein x is 1 or ½.
